(19) United States
(12) Patent Application Publication
(10) Pub. No.: US 2026/0112086 A1
(43) Pub. Date: Apr. 23, 2026

(54) IMAGE-TO-VIDEO GENERATION METHOD

(71) Applicant: Alibaba (China) Co., Ltd., Hangzhou (CN)

(72) Inventors: Yaping JIANG, Hangzhou (CN); Zulong CHEN, Hangzhou (CN); Jinke YU, Hangzhou (CN)

(73) Assignee: Alibaba (China) Co., Ltd., Hangzhou (CN)

(21) Appl. No.: 19/080,661

(22) Filed: Mar. 14, 2025

(30) Foreign Application Priority Data
Oct. 23, 2024 (CN) 202411493300.8

(51) Int. Cl. G06T 11/60; G06T 7/194; G06V 10/77

(52) U.S. Cl. CPC G06T 11/60; G06T 7/194; G06V 10/7715

(57) ABSTRACT

Provided is an image-to-video generation method. A source image including a target object is inputted into a first video generation model to obtain a material video. An interframe transform matrix sequence is determined according to the material video. An object masked image corresponding to the target object is obtained from the source image. The interframe transform matrix sequence is applied to the object masked image to obtain a masked image sequence including a plurality of masked images. The interframe transform matrix sequence is applied to the source image to obtain a target object image sequence including a plurality of target object images. Target input data is determined according to the source image, the masked image sequence and the target object image sequence. The target input data is inputted into a second video generation model supporting local redrawing to obtain a target video.

### CROSS-REFERENCE TO RELATED APPLICATIONS

The present application claims the priority of Chinese Patent Application No. 202411493300.8, entitled “Image-to-Video Generation Method and Apparatus”, and filed with the China National Intellectual Property Administration on Oct. 23, 2024, which is incorporated in the present disclosure by reference in its entirety.

### TECHNICAL FIELD

The present disclosure relates to the field of artificial intelligence, and in particular to an image-to-video generation method, an electronic device, and a non-transitory computer-readable storage medium.

### BACKGROUND

With the rapid development of artificial intelligence, a video generating technology has received extensive attention and been deeply studied. The currently popular image-to-video generation models are based on a diffusion model. Objects in the video generated by these models based on an image may have deformation and distortion, resulting in that the video cannot accurately reflect the real shape and details of the objects. In addition, the image-to-video generating model usually requires a user to preset a motion trajectory, which is complicated.

### SUMMARY

Embodiments of the present disclosure provide an image-to-video generation method, an electronic device, and a non-transitory computer-readable storage medium. Without introducing preset motion parameters, the diversity of motion trajectories is achieved while maintaining no spread of a target object area.

According to one aspect, the embodiments of the present disclosure provide an image-to-video generation method. The method includes: acquiring a source image, the source image comprising a target object; inputting the source image into a first video generation model to obtain a material video, wherein the first video generation model is a pretrained image-to-video model; determining an interframe transform matrix sequence corresponding to the material video; determining an object masked image corresponding to the target object in the source image; determining a target object image sequence according to the interframe transform matrix sequence and the source image; determining a masked image sequence according to the interframe transform matrix sequence and the object masked image; determining target input data according to the source image, the target object image sequence and the masked image sequence; and inputting the target input data into a second video generation model to obtain a target video, wherein the second video generation model is an image-to-video model with a local redrawing function or a video-to-video model with a local redrawing function.

According to another aspect, the embodiments of the present disclosure provide a non-transitory computer-readable storage medium. The computer-readable storage medium stores computer program instructions. When the computer program instructions are executed by a processor, the processor perform an image-to-video generation method. The method includes: acquiring a source image, the source image comprising a target object; inputting the source image into a first video generation model to obtain a material video, wherein the first video generation model is a pretrained image-to-video model; determining an interframe transform matrix sequence corresponding to the material video; determining an object masked image corresponding to the target object in the source image; determining a target object image sequence according to the interframe transform matrix sequence and the source image; determining a masked image sequence according to the interframe transform matrix sequence and the object masked image; determining target input data according to the source image, the target object image sequence and the masked image sequence; and inputting the target input data into a second video generation model to obtain a target video, wherein the second video generation model is an image-to-video model with a local redrawing function or a video-to-video model with a local redrawing function.

According to another aspect, the embodiments of the present disclosure provide an electronic device. The electronic device includes: a memory and a processor. The memory is configured to store one or more computer program instructions. When the one or more computer program instructions are executed by the processor, the processor perform an image-to-video generation method. The method includes: acquiring a source image, the source image comprising a target object; inputting the source image into a first video generation model to obtain a material video, wherein the first video generation model is a pretrained image-to-video model; determining an interframe transform matrix sequence corresponding to the material video; determining an object masked image corresponding to the target object in the source image; determining a target object image sequence according to the interframe transform matrix sequence and the source image; determining a masked image sequence according to the interframe transform matrix sequence and the object masked image; determining target input data according to the source image, the target object image sequence and the masked image sequence; and inputting the target input data into a second video generation model to obtain a target video, wherein the second video generation model is an image-to-video model with a local redrawing function or a video-to-video model with a local redrawing function.

According to another aspect, the embodiments of the present disclosure provide a computer program product. When running on the computer, the computer program product enables the computer to perform the image-to-video generation method.

According to the embodiments of the present disclosure, a source image including a target object is inputted into a first video generation model to obtain a material video, an interframe transform matrix sequence is determined according to the material video, an object mask image corresponding to the target object is obtained from the source image, the interframe transform matrix sequence is applied to the object mask image to obtain a mask image sequence including a plurality of mask images, the interframe transform matrix sequence is applied to the source image to obtain a target object image sequence including a plurality of target object images, the source image, the mask image sequence and the target object image sequence are converted into target input data meeting the input requirement of a second video generation model, and the target input data is inputted into the second video generation model supporting local redrawing to obtain a target video. Therefore, when the first video generation model is used, the interframe transform matrix is determined according to the obtained video, and the motion trajectory of the target object is described by the interframe transform matrix, and when the second video generation model is used, local redrawing of the video frame is controlled according to the interframe transform matrix, so that the target object in the generated target video is clear and not diffused. The video is generated by first and second video generation models, so that the end-to-end image-to-video is intelligent. Without using the preset motion parameter, the diversity of motion trajectories is achieved while maintaining no diffusion of the target object area.

### BRIEF DESCRIPTION OF DRAWINGS

The accompanying drawings, which are incorporated herein and constitute part of this specification, illustrate example embodiments, and together with the general description given above and the detailed description given below, serve to explain the features of various embodiments.

FIG. 1 is a flowchart of an image-to-video generation method according to one or more embodiments of the present disclosure;

FIG. 2 is a schematic diagram showing a working principle of a first video generation model according to one or more embodiments of the present disclosure;

FIG. 3 is a flowchart of a method for determining an interframe transform matrix sequence according to one or more embodiments of the present disclosure;

FIG. 4 is a flowchart of a method for determining a target object image sequence according to one or more embodiments of the present disclosure;

FIG. 5 is a flowchart of another method for determining a target object image sequence according to one or more embodiments of the present disclosure;

FIG. 6 is a flowchart of a method for determining a masked image sequence according to one or more embodiments of the present disclosure;

FIG. 7 is a flowchart of another method for determining a target object image sequence according to one or more embodiments of the present disclosure;

FIG. 8 is a flowchart of a method for determining target input data according to one or more embodiments of the present disclosure;

FIG. 9 is a flowchart of a method for generating a target video according to one or more embodiments of the present disclosure;

FIG. 10 is a schematic diagram showing a working principle of a second video generation model according to one or more embodiments of the present disclosure;

FIG. 11 is a flowchart of a method for generating a target video according to one or more embodiments of the present disclosure;

FIG. 12 is a schematic diagram showing a working principle of a second video generation model according to one or more embodiments of the present disclosure;

FIG. 13 is a flowchart of an image-to-video generation method according to one or more embodiments of the present disclosure;

FIG. 14 is a flowchart of an image-to-video generation apparatus according to one or more embodiments of the present disclosure; and

FIG. 15 is a schematic diagram of an electronic device according to one or more embodiments of the present disclosure.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

Moreover, those of ordinary skill in the art should understand that the accompanying drawings provided herein are for illustration only, and the accompanying drawings are not necessarily drawn to scale.

Unless the context clearly requires otherwise, similar words such as “including” and “containing” throughout the present disclosure should be interpreted as inclusive rather than exclusive or exhaustive; that is to say, it means “including but not limited to”.

In the present disclosure, it should be understood that the terms “first”, “second”, etc. are merely used for description, and cannot be understood as indicating or implying relative importance. Moreover, in the present disclosure, unless otherwise stated, “a plurality of” means two or more.

The embodiments described in the present disclosure, if involving personal information processing, may be processed on the premise of legality (e.g., obtaining the consent of the personal information subject or being necessary for the performance of the contract), and may only be processed within the specified or agreed scope. A user may refuse to process personal information other than the necessary information required for basic functions without affecting the user's use of basic functions.

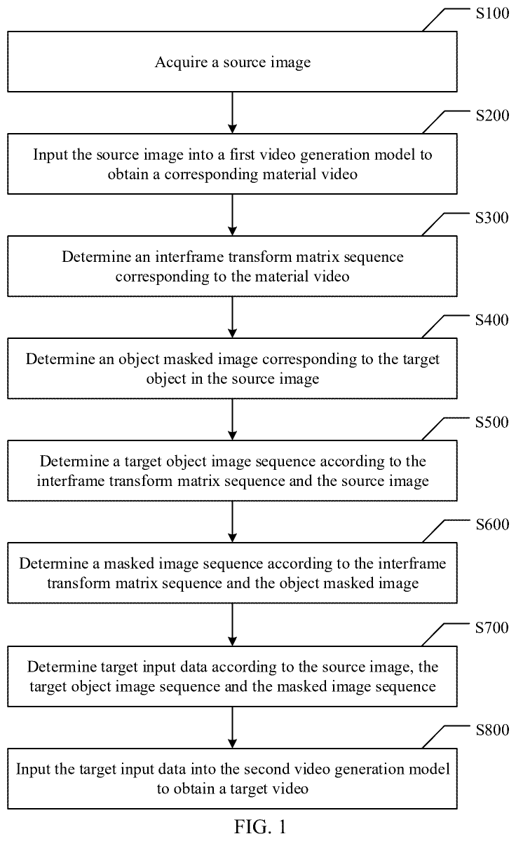

FIG. 1 is a flowchart of an image-to-video generation method according to one or more embodiments of the present disclosure. A video is generated from an image by the image-to-video generation method. As shown in FIG. 1, the image-to-video generation method includes the following steps.

Step S100: a source image is acquired.

The source image is an image including a target object. The target object is an object highlighted in the source image, such as commodities, animals, plants, people or animated characters.

Step S200: the source image is inputted into a first video generation model to obtain a corresponding material video.

The first video generation model is a pretrained image-to-video (I2V) model. The image-to-video model is configured to convert a static image into a dynamic video, and is widely applied in the fields of video production, advertising creativity, virtual reality and the like. The image-to-video model may be a generative model based on a diffusion model, such as stable diffusion and sora.

It should be noted that different types of target objects have different motion trajectories and motion features. For example, if the target object is the head of a person, the motion of the person in the generated video may be expression changes such as blinking, smiling and crying. If the target object is the body of a person, the motion of the person in the generated video may be body motions such as walking, turning around and throwing arms. If the target object is a commodity, the motion of the commodity in the generated video may be the change of light and shadow, the change of a visual angle and the change of a color projected on the commodity. Therefore, the image-to-video model in this embodiment is required to be trained in advance according to the type of the target object. The following embodiments will be explained by taking the case where the target object is a commodity as an example.

The pretraining process of the first video generation model is to collect a commodity display video with smooth and stable frame pictures and clear image quality and select an appropriate video frame from the commodity display video to serve a source image. The appropriate video frame refers to a video frame including a clear image of the commodity. A sample data set is constructed based on the commodity display video and the source image, and the sample data set is used to perform training and fine tuning on the image-to-video model to obtain the first video generation model with vertical-specific characteristics. The vertical-specific characteristics refer to unique attributes and requirements in a specific industry or field. In the embodiment of generating a commodity display video, the vertical-specific characteristics include light and shadow settings, detail display, commodity use scenario display, commodity performance parameters and other characteristics.

In some embodiments, the length of the material video generated by the first video generation model is preset, for example, the length of the material video generated by the first video generation model is 2 seconds, 4 seconds, 8 seconds and the like.

The first video generation model is put into use after training. The first video generation model generates a plurality of corresponding material video frames after receiving the source image, and generates a corresponding material video according to the plurality of material video frames, that is, the material video includes a plurality of material video frames.

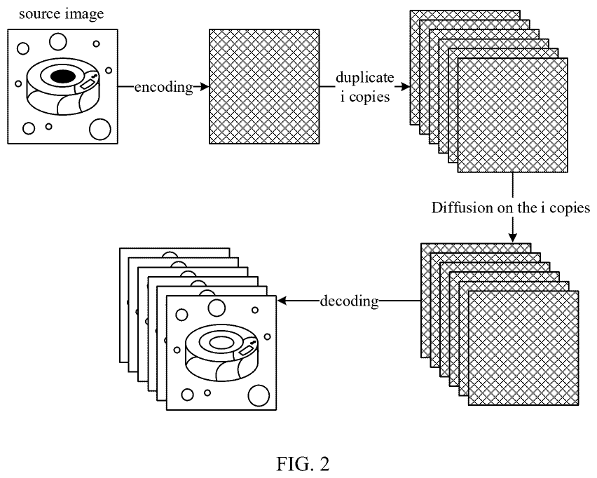

FIG. 2 is a schematic diagram showing a working principle of the first video generation model according to an embodiment of the present disclosure. As shown in FIG. 2, after the source image is inputted into the first video generation model, a coding module in the first video generation model codes the source image to obtain a coding result, for example, the coding module uses a convolutional neural network to extract advanced features of the input source image. These features indicate important information, such as edges, textures and objects in the image. Then the coding result is duplicated to obtain i coding results, that is, generate intermediate frames. For example, a generative adversarial network or a variational autoencoder is used to generate the intermediate frame. A series of intermediate frames are generated by learning a time evolution law of the image, so that a dynamic video is generated from a static image. Each of the intermediate frames is diffused to gradually add and remove noise to generate data so as to improve the video quality. Finally, the diffused video frames are decoded to obtain the material video.

Step S300: an interframe transform matrix sequence corresponding to the material video is determined.

The interframe transform matrix sequence is a series of transform matrices calculated for the change of objects or scenarios between consecutive frames. These transforms may include an affine transform, a projective transform and the like, and are used to capture the relative motion or change between two adjacent video frames. The affine transform is a linear transform combined with a translation operation. The affine transform retains the “straightness” and “collinearity” of points, straight lines and line segments, but does not retain the distance and angle. The common affine transform includes scaling, rotation, translation and shearing. The projective transform (also referred to as a perspective transform) is a more extensive transform and allows a perspective effect operation on images. The projective transform retains the properties of straight lines, but does not retain parallelism and proportion. The application of the projective transform includes image correction and 3D projection.

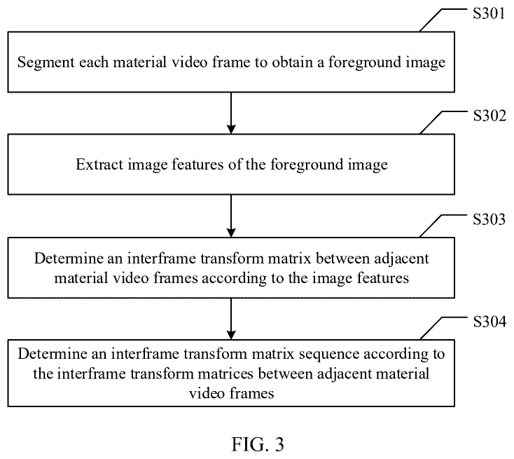

FIG. 3 is a flowchart of a method for determining an interframe transform matrix sequence according to an embodiment of the present disclosure. As shown in FIG. 3, the method for determining the interframe transform matrix sequence includes the following steps.

Step S301: image segmentation is performed on each of the material video frames to obtain a corresponding foreground image.

Each of the material video frames includes a target object and a background other than the target object; and the foreground image is an image of the target object. Object sub-images (that is, the foreground images) and background sub-images may be obtained by matting the material video frames.

Step S302: image features of the foreground image are extracted.

Calculation of various types of transforms, for example, the affine transform or the projective transform, requires image features. The image features include a scale-invariant feature transform (SIFT), speeded-up robust features (SURF), corner detection, canny edge features, features from accelerated segment test (FAST), feature matching pairs and the like.

Step S303: an interframe transform matrix between each pair of adjacent material video frames is determined according to the image features.

Specifically, after the image features of the foreground image are determined, feature matching is performed on adjacent material video frames to find out a corresponding relationship. The feature matching methods include brute-force matcher (BFMatcher), fast library for approximate nearest neighbors (FLANN) and the like.

After the feature matching is completed, the transform matrix between the adjacent material video frames is calculated through the matched feature point pairs. The transform matrix calculation methods include: a homography matrix, an affine transform matrix, a rigid transform matrix and the like. The homography matrix is suitable for plane scenario transform, the affine transform matrix is suitable for linear transform, and the rigid body transform matrix is suitable for rigid motion, including translation and rotation.

In some embodiments, the masked image in the background motion video frame is smoothed.

In some embodiments, the interframe transform matrix is smoothed.

Step S304: the interframe transform matrix sequence is determined according to the interframe transform matrices between each pair of adjacent material video frame.

In step S200 to step S300, the material video is determined by the first video generation model, so that the interframe transform matrix sequence is determined according to the material video. The interframe transform matrix sequence replaces motion trajectory parameters that are preset by a user in the existing art, so that the use difficulty is reduced and the motion parameter is generated intelligently.

Step S400: an object masked image corresponding to the target object in the source image is determined.

The object masked image is a binary image with the same size as the object sub-image (that is, the foreground image) or matched with the object sub-image.

Step S500: a target object image sequence is determined according to the interframe transform matrix sequence and the source image.

Specifically, a first target image of the target object image sequence is determined by applying a first interframe transform matrix in the interframe transform matrix sequence to the source image, an i^{th} target object image of the target object image sequence is determined by applying an i^{th} interframe transform matrix in the interframe transform matrix sequence to a last target object image of the current target object image sequence, the method is proceeded in such iterative manner until all interframe transform matrices in the interframe transform matrix sequence are applied, where i is a positive integer not greater than the number of the interframe transform matrices in the interframe transform matrix sequence.

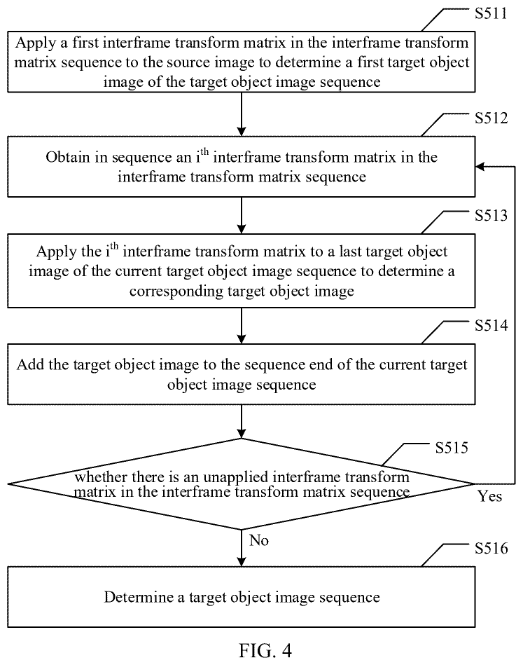

FIG. 4 is a flowchart of a method for determining a target object image sequence according to an embodiment of the present disclosure. As shown in FIG. 4, the method for determining the target object image sequence includes the following steps.

Step S511: a first target object image of the target object image sequence is determined by applying a first interframe transform matrix in the interframe transform matrix sequence to the source image.

Step S512: an i^{th} interframe transform matrix in the interframe transform matrix sequence is taken in sequence.

The i^{th} interframe transform matrix is an unapplied interframe transform matrix.

Step S513: the i^{th} interframe transform matrix is applied to a last target object image of the current target object image sequence, and a corresponding target object image is determined.

Step S514: the target object image is added to the target object image sequence, the target object image is after the current target object image, and the target object image is the last target object image of the updated target object image sequence.

Step S515: it is determined whether there is an unapplied interframe transform matrix in the interframe transform matrix sequence.

If there is an unapplied interframe transform matrix in the interframe transform matrix sequence, the method goes to step S512; and if there is no unapplied interframe transform matrix in the interframe transform matrix sequence, the method goes to step S516.

Step S516: a target object image sequence is determined.

For example, the interframe transform matrix sequence is {TM₁, TM₂, . . . TMₙ}. The first target object image I₁ is obtained by applying first interframe transform matrix TM₁ to the source image, and the target object image sequence is {I₁}. The second target object image I₂ is obtained by applying second interframe transform matrix TM₂ to the first target object image I₁, and the updated target object image sequence is {I₁, I₂}. The third target object image I₃ is obtained by applying third interframe transform matrix TM₃ to the second target object image I₂, and the updated target object image sequence is {I₁, I₂, I₃}. In this way, after the interframe transform matrix sequence is {TM₁, TM₂, ...TMₙ} is used, the target object image sequence is {I₁, I₂, I₃. . . Iₙ} is obtained.

The method for determining the target object image sequence shown in FIG. 4 is as follows: each interframe transform matrix in the interframe transform matrix sequence is sequentially applied to the last target object image of the current target object image sequence, and then the obtained target object image is sequentially added to the sequence end of the current target object image sequence, the method is proceeded until all the interframe transform matrices are applied.

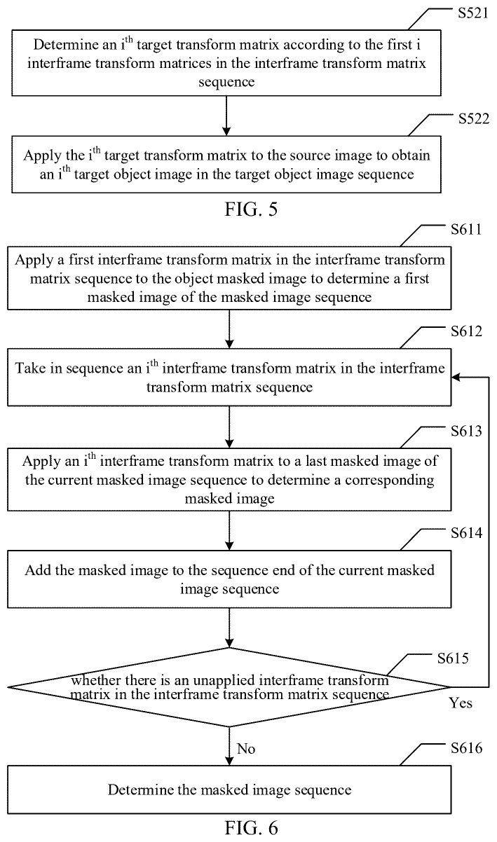

FIG. 5 is a flowchart of a method for determining a target object image sequence according to an embodiment of the present disclosure. As shown in FIG. 5, the method for determining the target object image sequence includes the following steps.

Step S521: an i^{th} target transform matrix is determined according to the first i interframe transform matrices (the first to the i^{th} interframe transform matrices) in the interframe transform matrix sequence.

Step S522: the i^{th} target transform matrix is applied to the source image to obtain an i^{th} target object image in the target object image sequence, where i is a positive integer not greater than the number of the interframe transform matrices in the interframe transform matrix sequence.

The method for determining the target object image sequence shown in FIG. 5 is as follows: an interframe transform matrix corresponding to each target object image in the target object image sequence is determined according to the interframe transform matrix sequence, and a target transform matrix required by converting the source image directly to the i^{th} target object image is determined according to the first to the i^{th} interframe transform matrices. For example, a target transform matrix corresponding to a second target object image is determined according to the first interframe transform matrix and the second interframe transform matrix in the interframe transform matrix sequence, and a target transform matrix corresponding to a fifth target object image is determined according to the first, second, third, fourth and fifth interframe transform matrices in the interframe transform matrix sequence. After being determined, the target transform matrix is directly applied to the source image to obtain the corresponding target object image. The target object image acquired by this method has higher definition.

Step S600: a masked image sequence is determined according to the interframe transform matrix sequence and the object masked image.

Specifically, a first interframe transform matrix in the interframe transform matrix sequence is applied to the object masked image to determine a first masked image of the masked image sequence, an i^{th} interframe transform matrix in the interframe transform matrix sequence is applied to a last masked image of the current masked image sequence to determine an i^{th} masked image of the masked image sequence, the method is proceeded in such iterative manner until all interframe transform matrices in the interframe transform matrix sequence are applied, where i is a positive integer not greater than the number of the interframe transform matrices in the interframe transform matrix sequence.

FIG. 6 is a flowchart of a method for determining a masked image sequence according to an embodiment of the present disclosure. As shown in FIG. 6, the method for determining the masked image sequence includes the following steps.

Step S611: a first interframe transform matrix in the interframe transform matrix sequence is applied to the object masked image to determine a first masked image of the masked image sequence.

Step S612: an i^{th} interframe transform matrix in the interframe transform matrix sequence is taken in sequence.

The i^{th} interframe transform matrix is an unapplied interframe transform matrix.

Step S613: an i^{th} interframe transform matrix is applied to a last masked image of the current masked image sequence to determine a corresponding masked image.

Step S614: the masked image is added after the current masked image.

Step S615: it is determined whether there is an unapplied interframe transform matrix in the interframe transform matrix sequence.

If there is an unapplied interframe transform matrix in the interframe transform matrix sequence, the method goes to step S612; and if there is no unapplied interframe transform matrix in the interframe transform matrix sequence, the method goes to step S616.

Step S616: a masked image sequence is determined.

The method for determining the masked image sequence shown in FIG. 6 is as follows: each interframe transform matrix in the interframe transform matrix sequence is sequentially applied to the last masked image of the current masked image sequence, and then the newly obtained masked image is added to the sequence end of the current masked image sequence in sequence, the method is proceeded until all interframe transform matrices are applied.

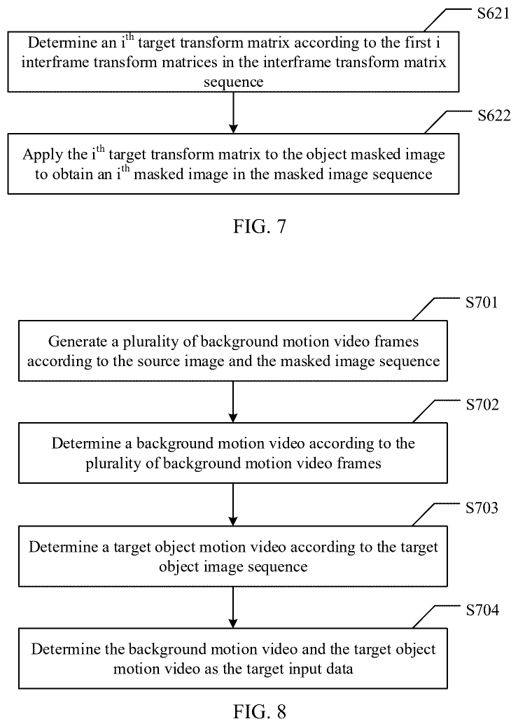

FIG. 7 is a flowchart of a method for determining a masked image sequence according to an embodiment of the present disclosure. As shown in FIG. 7, the method for determining the masked image sequence includes the following steps.

Step S621: an i^{th} target transform matrix is determined according to the first i interframe transform matrices in the interframe transform matrix sequence.

Step S622: the i^{th} target transform matrix is applied to the object masked image to obtain an i^{th} masked image in the masked image sequence, where i is a positive integer not greater than the number of the interframe transform matrices in the interframe transform matrix sequence.

The method for determining the masked image sequence shown in FIG. 7 is as follows: an interframe transform matrix corresponding to each masked image in the masked image sequence is determined according to the interframe transform matrix sequence, and a target transform matrix for converting the object masked image directly to the i^{th} masked image is determined according to the first to the i^{th} interframe transform matrices. For example, a target transform matrix corresponding to a second masked image is determined according to the first interframe transform matrix and the second interframe transform matrix in the interframe transform matrix sequence, and a target transform matrix corresponding to a fifth masked image is determined according to the first, second, third, fourth and fifth interframe transform matrices in the interframe transform matrix sequence. After being determined, the target transform matrix is directly applied to the object masked image to obtain the corresponding masked image. The masked image acquired by this method has higher definition.

Step S700: target input data is determined according to the source image, the target object image sequence and the masked image sequence.

The target input data is input data of a second video generation model, and the second video generation model is an image-to-video model or a video-to-video model with a local redrawing function.

It should be noted that compared with the first video generation model, the second video generation model further includes a local redrawing module in addition to an input data format, so the second video generation model is capable redrawing an area corresponding to a target object in the video.

In some embodiments, the second video generation model is an image-to-video model with a local redrawing function, and the corresponding input data is in an image format, so the source image, the target object image sequence and the masked image sequence are directly determined as the target input data.

In some embodiments, the second video generation model is a video-to-video model with a local redrawing function, the corresponding input data is in a video format, and the source image, the target object image sequence and the masked image sequence are converted into the video format.

FIG. 8 is a flowchart of a method for determining target input data according to an embodiment of the present disclosure. As shown in FIG. 8, the method for determining the target input data includes the following steps.

Step S701: a plurality of background motion video frames are generated according to the source image and the masked image sequence.

Specifically, the source image is copied and diffused, then each masked image in the masked image sequence is respectively used to process the source image, and the plurality of background motion video frames are obtained by modifying one or more pixels of a corresponding area in the source image.

Step S702: a background motion video is determined according to the plurality of background motion video frames.

Step S703: a target object motion video is determined according to the target object image sequence.

Step S704: the background motion video and the target object motion video are determined as the target input data.

Step S800: the target input data is inputted into the second video generation model to obtain a target video.

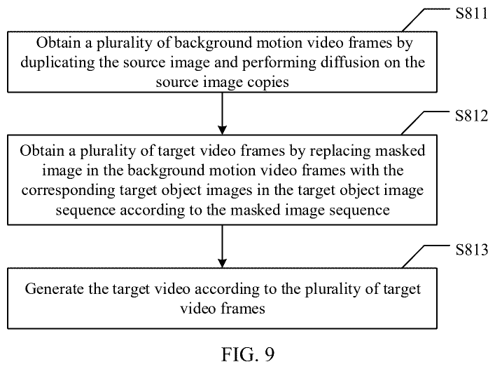

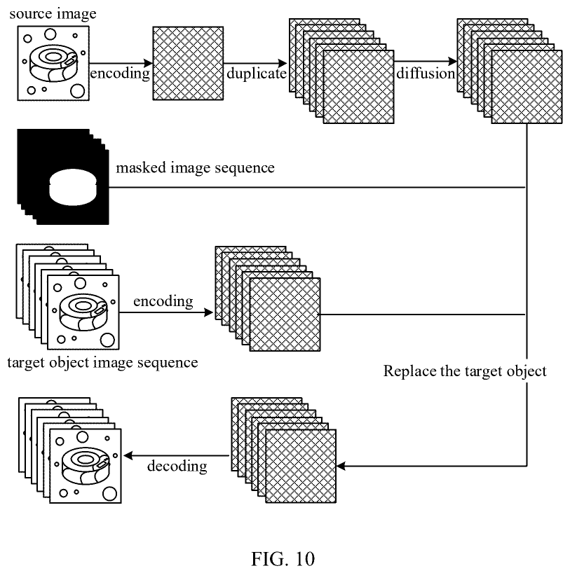

In some embodiments, the second video generation model is an image-to-video model with a local redrawing function, and the processing process of the second video generation model is shown in FIG. 9 and FIG. 10.

FIG. 9 is a flowchart of a method for generating a target video according to an embodiment of the present disclosure. FIG. 10 is a schematic diagram showing a working principle of a second video generation model according to an embodiment of the present disclosure. The method in FIG. 9 is explained with reference to the content shown in FIG. 10. As shown in FIG. 9, the method for generating the target video includes the following steps.

Step S811: the source image is copied and diffused to obtain a plurality of background motion video frames.

For the detail process of Step S811, please refer to FIG. 2. Details are not described herein again.

Step S812: a masked image in a background motion video frame is replaced with a corresponding target object image in the target object image sequence according to the masked image sequence to obtain a plurality of target video frames.

Specifically, the masked image sequence, the plurality of background motion video frames and the target object image sequence are matched to obtain multiple replacement data groups, and the replacement data group includes the masked image, the background motion video frame and the target object image. For each replacement data group, a corresponding local area in the background motion video frame is replaced with the target object image according to the masked image to obtain a corresponding target video frame.

Step S813: the corresponding target video is generated according to the plurality of target video frames.

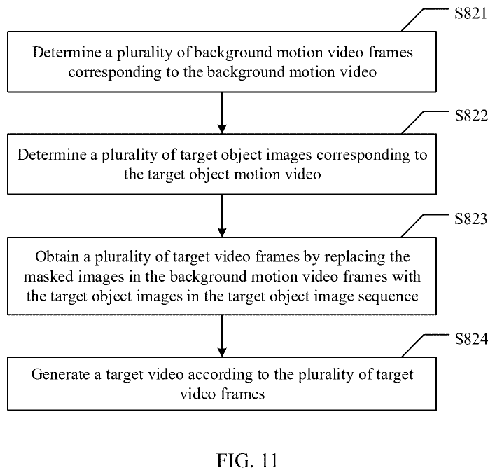

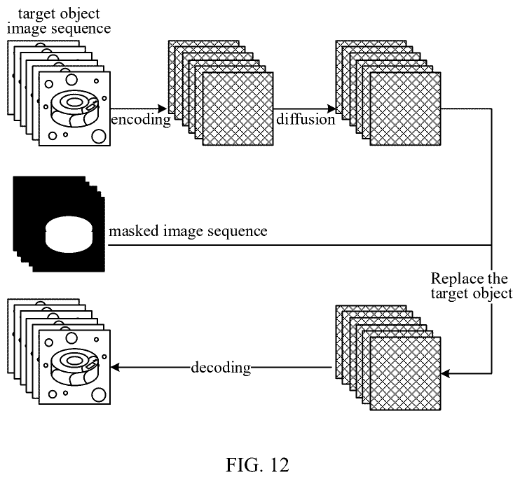

In some embodiments, the second video generation model is a video-to-video model with a local redrawing function, and the processing process of the second video generation model is shown in FIG. 11 and FIG. 12.

FIG. 11 is a flowchart of a method for generating a target video according to an embodiment of the present disclosure. FIG. 12 is a schematic diagram showing a working principle of a second video generation model according to an embodiment of the present disclosure. The method in FIG. 11 is explained with reference to the content shown in FIG. 12. As shown in FIG. 11, the method for generating the target video includes the following steps.

Step S821: the plurality of background motion video frames corresponding to the background motion video are determined.

This step is to convert the input video into a plurality of corresponding video frames.

Step S822: a plurality of target object images corresponding to the target object motion video are determined.

That is, a target object image sequence corresponding to the target object motion video is determined.

Step S823: the masked images in the background motion video frames are replaced with the target object images in the target object image sequence to obtain a plurality of target video frames.

Step S824: the corresponding target video is generated according to the plurality of target video frames.

The method shown in FIG. 11 is to parse an image into an image frame, and a processing method after the image frame is obtained is similar to the method shown in FIG. 9, so the details are not repeated herein.

The method according to the embodiments of the present disclosure includes: a source image including a target object is inputted into a first video generation model to obtain a material video, an interframe transform matrix sequence is determined according to the material video, then an object masked image corresponding to the target object is obtained from the source image, the interframe transform matrix sequence is applied to the object masked image to obtain a plurality of masked images so as to form a masked image sequence, the interframe transform matrix sequence is applied to the source image to obtain a plurality of target object images so as to form a target object image sequence, the source image, the masked image sequence and the target object image sequence are converted into target input data meeting the input requirement of a second video generation model, and the target input data is inputted into the second video generation model supporting local redrawing to obtain a corresponding target video. Therefore, in the method according to the embodiments of the present disclosure, a motion trajectory of the target object is described by the interframe transform matrix sequence calculated from the material video generated by the first video generation model, so that the motion trajectory is generated by intelligence, and the problem that the preset motion trajectory of the target object is relatively simple or the motion trajectory is fixed is solved. In the method of the method embodiment, a local drawing function is added in the video generation process of the second video generation model by the calculated interframe transform matrix sequence, thereby keeping the foreground area corresponding to the target object within the controllable range.

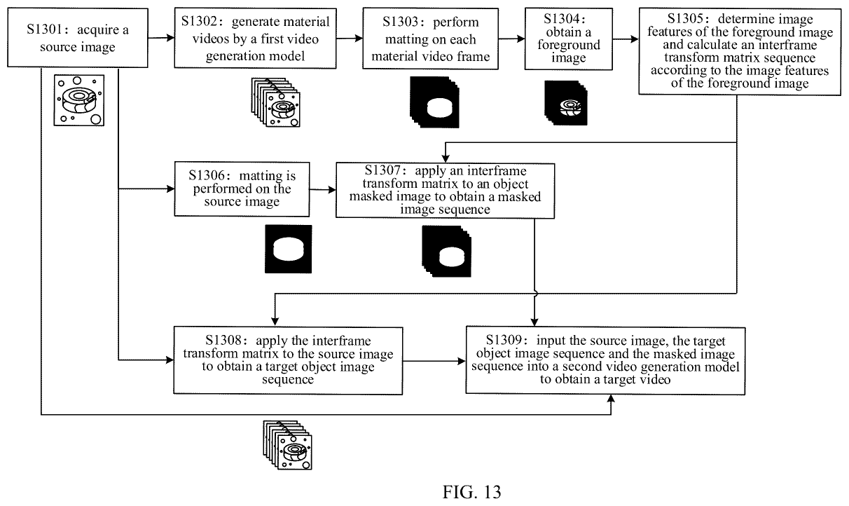

FIG. 13 is a flowchart of an image-to-video generation method according to an embodiment of the present disclosure. As shown in FIG. 13, the image-to-video generation method includes the following steps.

Step S1301: a source image is acquired.

Step S1302: the material video is generated by the first video generation model.

The material video includes a plurality of material video frames.

Step S1303: matting is performed on each of the material video frames.

Step S1304: a foreground image is obtained.

Step S1305: according to an image feature of the foreground image, it is determined to calculate an interframe transform matrix sequence according to a foreground feature.

Step S1306: matting is performed on the source image to obtain a masked image.

Step S1307: an interframe transform matrix is applied to an object masked image to obtain a masked image sequence.

Step S1308: the interframe transform matrix is applied to the source image to obtain a target object image sequence.

Step S1309: the source image, the target object image sequence and the masked image sequence are inputted into a second video generation model to obtain a corresponding target video.

The details of steps S1301 to S1309 are similar to the corresponding process of the above embodiment, and thus will not be elaborated herein.

The method according to the embodiments of the present disclosure includes: a source image including a target object is inputted into a first video generation model to obtain a material video, an interframe transform matrix sequence is determined according to the material video, then an object masked image corresponding to the target object is obtained from the source image, the interframe transform matrix sequence is applied to the object masked image to obtain a plurality of masked images so as to form a masked image sequence, the interframe transform matrix sequence is applied to the source image to obtain a plurality of target object images so as to form a target object image sequence, the source image, the masked image sequence and the target object image sequence are converted into target input data meeting the input requirement of a second video generation model, and the target input data is inputted into the second video generation model supporting local redrawing to obtain a corresponding target video. Therefore, in the method according to the embodiments of the present disclosure, a motion trajectory of the target object is described by the interframe transform matrix sequence calculated from the material video generated by the first video generation model, so that the motion trajectory is generated by intelligence, and the problem that the preset motion trajectory of the target object is relatively simple or the motion trajectory is fixed is solved. In the method of the method embodiment, a local drawing function is added in the video generation process of the second video generation model by the calculated interframe transform matrix sequence, thereby keeping the foreground area corresponding to the target object within the controllable range.

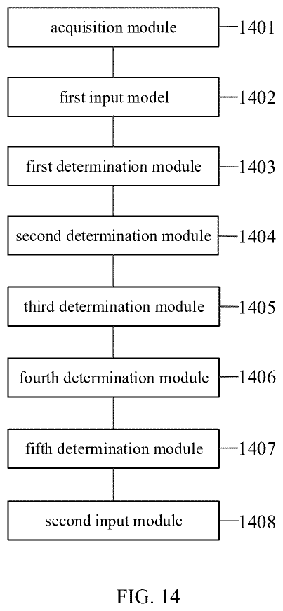

FIG. 14 is a schematic diagram of an image-to-video generation apparatus according to an embodiment of the present disclosure. As shown in FIG. 14, the image-to-video generation apparatus includes: an acquisition module 1401, a first input model 1402, a first determination module 1403, a second determination module 1404, a third determination module 1405, a fourth determination module 1406, a fifth determination module 1407, and a second input model 1408.

The acquisition module 1401 is configured to acquire a source image, where the source image is an image comprising a target object.

The first input model 1402 is configured to input the source image into a first video generation model to obtain a material video, where the first video generation model is a pretrained image-to-video model;

The first determination module 1403 is configured to determine an interframe transform matrix sequence corresponding to the material video.

The second determination module 1404 is configured to determine an object masked image corresponding to the target object in the source image.

The third determination module 1405 is configured to determine a target object image sequence according to the interframe transform matrix sequence and the source image.

The fourth determination module 1406 is configured to determine a masked image sequence according to the interframe transform matrix sequence and the object masked image.

The fifth determination module 1407 is configured to determine target input data according to the source image, the target object image sequence and the masked image sequence.

The second input model 1408 is configured to input the target input data into a second video generation model to obtain a corresponding target video, where the second video generation model is an image-to-video model or a video-to-video model with a local redrawing function.

According to the apparatus of the embodiments of the present disclosure, a source image including a target object is inputted into a first video generation model to obtain a material video, an interframe transform matrix sequence is determined according to the material video, an object mask image corresponding to the target object is obtained from the source image, the interframe transform matrix sequence is applied to the object mask image to obtain a mask image sequence including a plurality of mask images, the interframe transform matrix sequence is applied to the source image to obtain a target object image sequence including a plurality of target object images, the source image, the mask image sequence and the target object image sequence are converted into target input data meeting the input requirement of a second video generation model, and the target input data is inputted into the second video generation model supporting local redrawing to obtain a target video. Therefore, when the first video generation model is used, the interframe transform matrix is determined according to the obtained video, and the motion trajectory of the target object is described by the interframe transform matrix, and when the second video generation model is used, local redrawing of the video frame is controlled according to the interframe transform matrix, so that the target object in the generated target video is clear and not diffused. The video is generated by first and second video generation models, so that the end-to-end image-to-video is intelligent. Without using the preset motion parameter, the diversity of motion trajectories is achieved while maintaining no diffusion of the target object area.

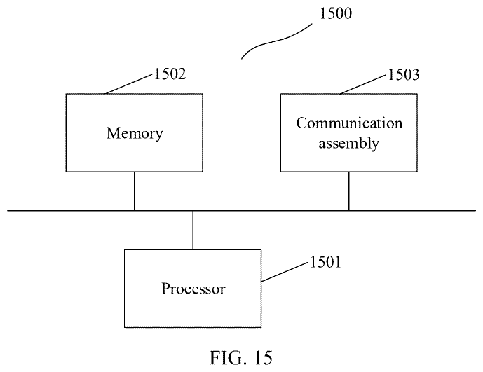

FIG. 15 is a schematic diagram of an electronic device according to an embodiment of the present disclosure. In this embodiment, the electronic device 150 may be a server, a terminal and the like. As shown in FIG. 15, the electronic device 150 includes: at least one processor 1501, a memory 1502 in communication connection with the at least one processor 1501, and a communication assembly 1503. The communication assembly 1503 receives and transmits data under the control of the at least one processor 1501. The memory 1502 stores instructions executable by the at least one processor 1501. The instructions are executed by the at least one processor 1501 to implement the above image-to-video generation method.

Specifically, the electronic device includes: one or more processors 1501 and a memory 1502. In the example embodiment of FIG. 15, the electronic device includes one processor 1501. The processor 1501 and the memory 1502 are connected through a bus or other manners. In the example embodiment of FIG. 15, the processor 1501 and the memory 1502 are connected through the bus. The memory 1502, as a nonvolatile computer-readable storage medium, is configured to store a nonvolatile software program, a nonvolatile computer-executable program and a module. The processor 1501 executes various functional applications of the device and data processing by running the nonvolatile software program, the instruction and the module stored in the memory 1502, that is, the above video generating method is implemented.

The memory 1502 may include a program storage area and a data storage area. The program storage area may store an operating system and an application required by at least one function. The data storage area may store an option list and the like. In addition, the memory 1502 may include a high-speed random access memory, and may further include a nonvolatile memory, such as at least one disk storage device, a flash memory device or other volatile solid-state storage devices. In some optional embodiments, the memory 1502 optionally includes memories remotely arranged relative to the processor 1501, and these remote memories may be connected to external devices through networks. The examples of the above networks include, but are not limited to, Internet, Intranet, a local area network, a mobile communication network and a combination thereof.

One or more modules are stored in the memory 1502. When the one or more modules are executed by one or more processors 1501, the image-to-video generation method in the above any method embodiment is performed.

The above products may perform the method provided in the embodiments of the present disclosure, and have corresponding functional modules and beneficial effects for performing the method. For technical details not described in detail in the present embodiment, reference may be made to the method provided in the embodiments of the present disclosure.

According to the embodiments of the present disclosure, a source image including a target object is inputted into a first video generation model to obtain a material video, an interframe transform matrix sequence is determined according to the material video, then an object masked image corresponding to the target object is obtained from the source image, the interframe transform matrix sequence is applied to the object masked image to obtain a plurality of masked images so as to form a masked image sequence, the interframe transform matrix sequence is applied to the source image to obtain a plurality of target object images so as to form a target object image sequence, the source image, the masked image sequence and the target object image sequence are converted into target input data meeting the input requirement of a second video generation model, and the target input data is inputted into the second video generation model supporting local redrawing to obtain a corresponding target video. Therefore, in the method according to the embodiments of the present disclosure, a motion trajectory of the target object is described by the interframe transform matrix sequence calculated from the material video generated by the first video generation model, so that the motion trajectory is generated by intelligence, and the problem that the preset motion trajectory of the target object is relatively simple or the motion trajectory is fixed is solved. In the method of the method embodiment, a local drawing function is added in the video generation process of the second video generation model by the calculated interframe transform matrix sequence, thereby keeping the foreground area corresponding to the target object within the controllable range.

Another embodiment of the present disclosure relates to a nonvolatile storage medium for storing a non-transitory computer-readable program. The non-transitory computer-readable program is used for a computer to perform some or all of the above method embodiments.

That is, those skilled in the art can understand that all or some of the steps in the methods of the above embodiments can be performed by instructing related hardware through a program. The program is stored in a storage medium and includes several instructions to enable a device (which may be a single-chip microcomputer, a chip, or the like) or a processor (processor) to perform all or some of the steps of the methods in the embodiments of the present application. The storage medium includes: various mediums that can store program code, such as a USB flash drive, a mobile hard disk, a read-only memory (ROM), a random access memory (RAM), a magnetic disk, or an optical disk.

The above description is merely embodiments of the present disclosure and is not intended to limit the present disclosure. For those skilled in the art, the present disclosure may have various modifications and changes. Any modification, equivalent replacement, improvement, etc. made within the spirit and principle of the present disclosure shall be included in the scope of the claims of the present disclosure.

What is claimed is:

1. An image-to-video generation method, comprising:
acquiring a source image, the source image comprising a target object;
inputting the source image into a first video generation model to obtain a material video, wherein the first video generation model is a pretrained image-to-video model;
determining an interframe transform matrix sequence corresponding to the material video;
determining an object masked image corresponding to the target object in the source image;
determining a target object image sequence according to the interframe transform matrix sequence and the source image;
determining a masked image sequence according to the interframe transform matrix sequence and the object masked image;
determining target input data according to the source image, the target object image sequence and the masked image sequence; and
inputting the target input data into a second video generation model to obtain a target video, wherein the second video generation model is an image-to-video model with a local redrawing function or a video-to-video model with a local redrawing function.

2. The method according to claim 1, wherein the material video includes a plurality of material video frames, and
the determining an interframe transform matrix sequence corresponding to the material video comprises:
performing image segmentation on the material video frames to obtain foreground images, the foreground images being images of the target object,
extracting image features of the foreground images,
determining an interframe transform matrix between each pair of adjacent material video frames of the plurality of material video frames according to the image features, and
determining the interframe transform matrix sequence according to the interframe transform matrix between each pair of adjacent material video frames of the plurality of material video frames.

3. The method according to claim 1, wherein the determining a target object image sequence according to the interframe transform matrix sequence and the source image comprises:
applying a first interframe transform matrix in the interframe transform matrix sequence to the source image to determine a first target object image of the target object image sequence; and
applying an i^{th} interframe transform matrix in the interframe transform matrix sequence to a last target object image of a current target object image sequence to determine an i^{th} target object image of the target object image sequence, proceeding in such iterative manner until all interframe transform matrices in the interframe transform matrix sequence are applied, where i is a positive integer not greater than a number of the interframe transform matrices in the interframe transform matrix sequence.

4. The method according to claim 1, wherein the determining a target object image sequence according to the interframe transform matrix sequence and the source image comprises:
determining an i^{th} target transform matrix according to the first i interframe transform matrices in the interframe transform matrix sequence; and
applying the i^{th} target transform matrix to the source image to obtain an i^{th} target object image in the target object image sequence, wherein i is a positive integer not greater than a number of the interframe transform matrices in the interframe transform matrix sequence.

5. The method according to claim 1, wherein the determining a masked image sequence according to the interframe transform matrix sequence and the object masked image comprises:
applying a first interframe transform matrix in the interframe transform matrix sequence to the object masked image, and determining a first masked image of the masked image sequence; and
applying an i^{th} interframe transform matrix in the interframe transform matrix sequence to a last masked image of a current masked image sequence to determine an i^{th} masked image of the masked image sequence, proceeding in such iterative manner until all interframe transform matrices in the interframe transform matrix sequence are applied, wherein i is a positive integer not greater than a number of the interframe transform matrices in the interframe transform matrix sequence.

6. The method according to claim 1, wherein the determining a masked image sequence according to the interframe transform matrix sequence and the object masked image comprises:
determining an i^{th} target transform matrix according to the first i interframe transform matrices in the interframe transform matrix sequence; and
applying the i^{th} target transform matrix to the object masked image to obtain an i^{th} masked image in the masked image sequence, wherein i is a positive integer not greater than a number of the interframe transform matrices in the interframe transform matrix sequence.

7. The method according to claim 1, wherein the second video generation model is an image-to-video model with a local redrawing function, and
the determining target input data according to the source image, the target object image sequence and the masked image sequence comprises:
determining the source image, the target object image sequence and the masked image sequence as the target input data.

8. The method according to claim 1, wherein the second video generation model is a video-to-video model with a local redrawing function, and
the determining target input data according to the source image, the target object image sequence and the masked image sequence comprises:
generating a plurality of background motion video frames according to the source image and the masked image sequence,
determining a background motion video according to the plurality of background motion video frames,
determining a target object motion video according to the target object image sequence, and
determining the background motion video and the target object motion video as the target input data.

9. The method according to claim 8, wherein the generating a plurality of background motion video frames according to the source image and the masked image sequence comprises:
duplicating the source image to obtain source image copies and performing diffusion on the source image copies; and
generating the plurality of background motion video frames according to the source image copies and the masked image sequence.

10. The method according to claim 7, wherein after the target input data is inputted into the second video generation model, the second video generation model generates the target video by the following steps:
duplicating the source image to obtain source image copies and performing diffusion on the source image copies to obtain a plurality of background motion video frames;
replacing the masked images in the background motion video frames with the target object images in the target object image sequence according to the masked image sequence to obtain a plurality of target video frames; and
generating the target video according to the plurality of target video frames.

11. The method according to claim 8, wherein after the target input data is inputted into the second video generation model, the second video generation model generates the target video by the following steps:
determining the plurality of background motion video frames corresponding to the background motion video;
determining a plurality of target object images corresponding to the target object motion video;
replacing masked images in the background motion video frames with the target object images in the target object image sequence to obtain a plurality of target video frames; and
generating the target video according to the plurality of target video frames.

12. An electronic device, comprising a memory and a processor, wherein the memory is configured to store one or more computer program instructions, and the one or more computer program instructions are executed by the processor to implement an image-to-video generation method, wherein the image-to-video generation method comprises:
acquiring a source image, the source image comprising a target object;
inputting the source image into a first video generation model to obtain a material video, wherein the first video generation model is a pretrained image-to-video model;
determining an interframe transform matrix sequence corresponding to the material video;
determining an object masked image corresponding to the target object in the source image;
determining a target object image sequence according to the interframe transform matrix sequence and the source image;
determining a masked image sequence according to the interframe transform matrix sequence and the object masked image;
determining target input data according to the source image, the target object image sequence and the masked image sequence; and
inputting the target input data into a second video generation model to obtain a target video, wherein the second video generation model is an image-to-video model with a local redrawing function or a video-to-video model with a local redrawing function.

13. A non-transitory computer-readable storage medium, storing a computer program, wherein when the computer program is executed by a processor, an image-to-video generation method is implemented, wherein the image-to-video generation method comprises:
acquiring a source image, the source image comprising a target object;
inputting the source image into a first video generation model to obtain a material video, wherein the first video generation model is a pretrained image-to-video model;
determining an interframe transform matrix sequence corresponding to the material video;
determining an object masked image corresponding to the target object in the source image;
determining a target object image sequence according to the interframe transform matrix sequence and the source image;
determining a masked image sequence according to the interframe transform matrix sequence and the object masked image;
determining target input data according to the source image, the target object image sequence and the masked image sequence; and
inputting the target input data into a second video generation model to obtain a target video, wherein the second video generation model is an image-to-video model with a local redrawing function or a video-to-video model with a local redrawing function.
